(19) United States
(12) Patent Application Publication
(10) Pub. No.: US 2016/0148772 A1
(43) Pub. Date: May 26, 2016

(54) SWITCH WITH OVERLOAD RELEASE ABILITY

(71) Applicant: Tsung-Mou Yu, New Taipei City (TW)

(72) Inventor: Tsung-Mou Yu, New Taipei City (TW)

(21) Appl. No.: 14/549,790

(22) Filed: Nov. 21, 2014

(51) Int. Cl. H01H 73/04

(52) U.S. Cl. CPC H01H 73/04

(57) ABSTRACT

A switch includes first and second conductive prongs that have upper portions located within a switch casing and lower portions exposed therefrom, a button mounted pivotally on the casing having a connection rod and a stop rod extending into the casing; and an alloy plate disposed within the casing having one end connected securely to the upper portion of the second prong and a free end operably connected to the connection rod. The free end is provided with an upper electrical contact in alignment with a lower electrical contact of the first conductive prong. A support unit biases the alloy plate from below such that the upper and lower electrical contacts touch relative to each other meanwhile the lowest end of the stop rod is spaced apart from the alloy plate.

### BACKGROUND OF THE INVENTION

1. Field of the Invention

The present invention relates to a switch for controlling a circuit, more particularly to a switch, which has overload release ability such that in case an overload current flows through the switch in a switch-on position, an open circuit will automatically result in so as to prevent the switch from being damaged.

2. The Prior Arts

A conventional switch generally includes a button switchable between a switch-on position, where a looped circuit is resulted in the switch, and a switch-off position, where an open circuit is resulted in the switch so that current will not flow therethrough. A majority of the switches presently available are provided with overload release structures or ability, such as by installing fuses or circuit breakers, so as to prevent the switches from being damaged when an overload current flows through therethrough.

Some U.S. Pat. Nos. 4,167,720; 4,937,548; 5,223,813; 5,451,729 and 5,558,211 respectively disclose a switch with overload release structure. The applicant possesses U.S. Pat. No. 5,262,748 regarding a switch with overload release structure or ability.

Referring to FIGS. 3A and 3B, a conventional switch with an automatic overload release structure includes a switch casing A defining an interior chamber, first, second and third conductive prongs C1, C2, C3 disposed within the interior chamber and having lower prong sections exposed from the switch casing A such that the lower prong sections of the first and second prongs C1, C2 are used for electrically connection with the fire and neutral wires of an electrical power source while the lower prong section of the third prong C3 is used for grounding or earthing, wherein the upper prong section of the first prong C1 is provided with a lower electrical contact C11 while the upper prong section of the second prong C2 is connected securely to one end of a heat-deformable alloy plate D. The alloy plate D further has a free end provided with an upper electrical contact D1 in alignment with the lower electrical contact C1. A support unit A2 is disposed in the interior chamber below the alloy plate D to bias the same such that the alloy plate abuts against an upper abutment unit A1. A button B is mounted pivotally on the switch casing A, includes a connection rod B1 having a barbed lower end B11 operably connected to the free end of the alloy plate D.

Pressing downward of a first end of the button B in the arrow direction (see FIG. 3A) results in simultaneous downward movement of the connection rod B1, thereby causing touching between the lower and upper electrical contacts C11, D1, where a looped circuit is formed between the first and second prongs C1, C2 via the alloy plate D such that the button B is disposed in a switch-on position.

Pressing downward of a second end of the button B as shown FIG. 3B results in simultaneous upward movement of the connection rod B1 together with the alloy plate D, thereby causing separation between the lower and upper electrical contacts C11, D1 where an open circuit is formed between the first and second prongs C1, C2 such that the button B is disposed in a switch-off position.

One drawback of the above-mentioned switch resides in that in case of an overload current flows therethrough results in overheat situation, the alloy plate D deforms due to the temperature of the overheat exceeds the predetermined deformation temperature of the alloy plate D. During deforming, the free end of the alloy plate D will deform tremendously and buckles upward owing to the alloy plate be pressed against by the support unit A2 located below the alloy plate D and the abutment unit Al located above the alloy plate D such that the upper electrical contact D1 disengages from the lower electrical contacts C11, thereby forming the undesired open circuit (see FIG. 3B) between the first and second prongs C1, C2.

It is noted that the upper surface of the alloy plate D is interfered by the abutment unit A1 due to an overload current flows through the alloy plate D and causes temperature elevating, and advance to cause abnormal or stop disengaging.

### SUMMARY OF THE INVENTION

Therefore, the objective of the present invention is to provide a switch with an automatic overload release structure so as to avoid the possibility occurrence of the above-mentioned problem.

One specific feature of the present invention is to provide a sufficient space to permit release of an alloy plate in the switch such that in case of an overload current flows therethough deformation of the alloy plate is not restricted by the space such that no short circuit will be resulted in the switch of the present invention.

A switch with automatic overload release ability of the present invention includes a switch casing, a button and an alloy plate. The switch casing defines an interior chamber with a bottom, includes first and second conductive prongs disposed within the interior chamber and having lower prong portions exposed to an exterior of the interior chamber via the bottom and upper prong portions located within the interior chamber and a support unit. The upper prong portion of the first prong is provided with a lower electrical contact. The button is mounted pivotally on the switch casing, has a first end provided with a connection rod extending into the interior chamber and a second end provided with a stop rod extending into the interior chamber. The alloy plate is disposed within the interior chamber below the connection and stop rods, has one end connected securely to the upper prong portion of the second prong and a free end operably connected to the connection rod. The free end is provide with an upper electrical contact in alignment with the lower electrical contact of the first prong while the support unit biases the alloy plate from below such that when the button is switched on results in downward movement of the connection rod together with the alloy plate, thereby touching the upper and lower electrical contacts relative to each other while the stop rod is spaced apart from the alloy plate and when the button is switched off results in downward movement of the stop rod pressing against the alloy plate so as to separate the upper and lower electrical contacts from each other. When the button is in the switch-on position and when an overload current flows through the first and second prongs via the alloy plate results in deformation of the alloy plate from its initial shape and causes untimely separation of the upper and lower electrical contacts from each other upon reaching a default value owing to space apart of the stop rod from the alloy plate, thereby forming an open circuit between the first and second prongs and preventing the switch from being damaged.

In one embodiment of the present invention, the stop rod extends downwardly and integrally from the button, which is made of an insulated material.

In another embodiment, the switch of the present invention further includes a third conductive prong disposed within the interior chamber and having a lower prong portion exposed to an exterior of the switch casing for connection with a ground wire of an electrical power source once the switch is mounted on a wall.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a perspective view of a switch with an overload release ability of the present invention;

FIG. 2A shows a cross-sectional view of the switch of the present invention in a switch-on position;

FIG. 2B shows a cross-sectional view of the switch of the present invention in a switch-off position;

FIG. 3A shows a cross-sectional view of a conventional switch of in a switch-on position; and

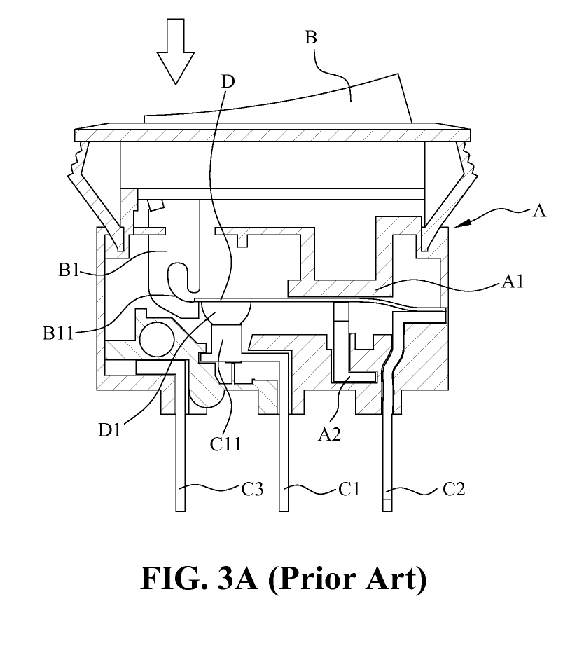

FIG. 3B shows a cross-sectional view of the conventional switch in a switch-off position.

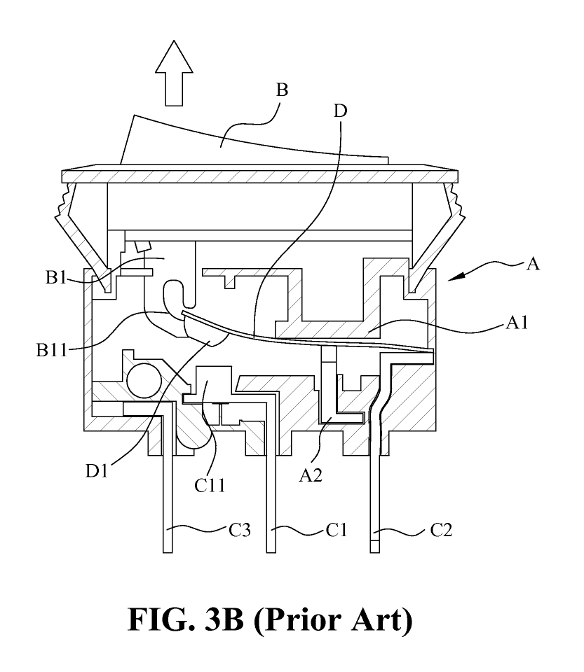

### DETAILED DESCRIPTION OF THE PREFERRED EMBODIMENT

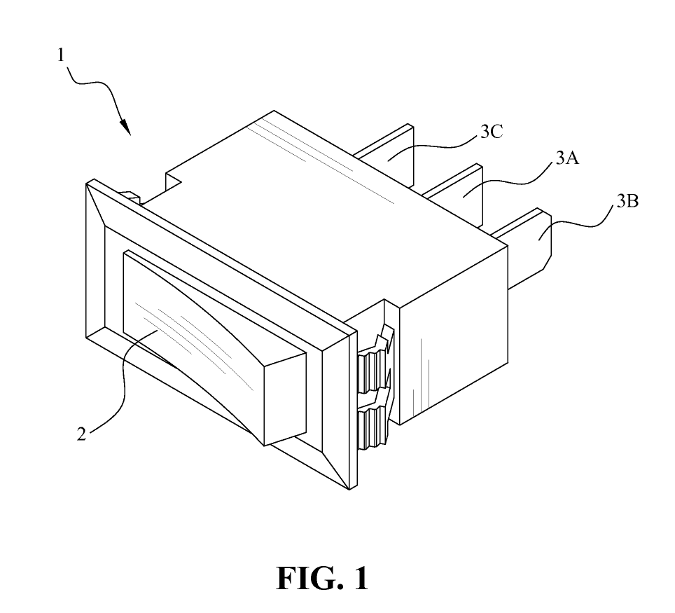

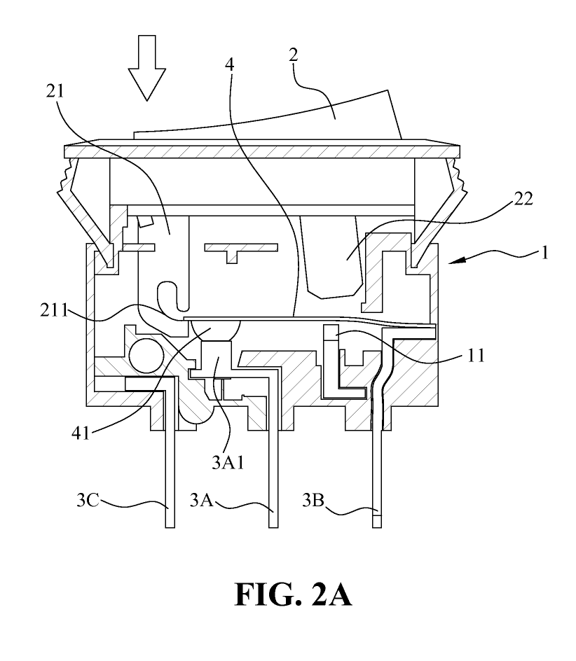

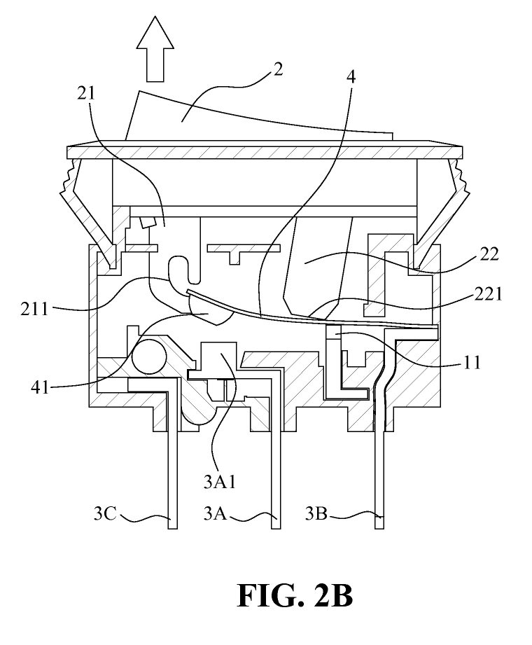

Referring to FIGS. 1 to 2A, wherein FIG. 1 shows a perspective view of a switch with an overload release ability of the present invention; and FIG. 2A shows a cross-sectional view of the switch of the present invention in a switch-on position. As shown, the switch with an overload release ability of the present invention includes a switch casing 1, a button 2 and an alloy plate 4. The switch casing 1 defines an interior chamber with a bottom, includes first and second conductive prongs 3A, 3B that are disposed within the interior chamber and that have lower prong portions exposed to an exterior of the interior chamber via the bottom for electrically coupling to a hot wire and a neutral wire of an electrical power source. The first and second conductive prongs 3A, 3B further have upper prong portions located within the interior chamber and a support unit 11. The switch casing 1 further includes a third conductive prong 3C that is disposed within the interior chamber and that has a lower prong portion exposed to exterior of the interior chamber for connecting with the ground. The upper prong portion of the first conductive prong 3A is provided with a lower electrical contact 3A1. The support unit 11 is disposed in the interior chamber between the first and second prongs 3A, 3B, the purpose of which will be described in the following paragraphs.

The button 2 is mounted pivotally on the switch casing 1, has a first end provided with a connection rod 21 extending into the interior chamber and a second end provided with a stop rod 22 extending into the interior chamber.

The alloy plate 4 is disposed within the interior chamber below the connection and stop rods 21, 22, and has one end connected securely to the upper prong portion of the second prong 3B and a free end operably connected to the connection rod 21. The free end of the alloy plate 4 is provided with an upper electrical contact 41 in alignment with the lower electrical contact 3A1 of the first prong 3A while the support unit 11 biases the alloy plate 4 from below. Note the lower barbed portion 211 of the connection rod 21 is hooked to the free end of the alloy plate 4.

After assembly, when the button 2 is switched on, in which the button 2 is pressed as shown by the arrow direction (see FIG. 2A) results in downward movement of the connection rod 21 together with the alloy plate 4, thereby touching the upper and lower electrical contacts 41, 3A1 relative to each other while the stop rod 22 is spaced apart from the alloy plate 4. At this time, a looped circuit is formed between the first and second prongs 3A, 3B via the alloy plate 4 and current can flow therethrough.

After assembly, when the button 2 is switched off, in which the button 2 pivots in the arrow direction as shown in FIG. 2B, which results in downward movement of the stop rod 22 while the connection rod 21 and the alloy plate 4 move together upward, thereby causing the stop rod 22 to pressing against the alloy plate 4 so as to separate the upper and lower electrical contacts 41, 3A1 from each other. At this time, an open circuit is established between the first and second prongs 3A, 3B and no current flows therethrough.

When the button 2 is in the switch-on position and (in case of) an overload current flows through the first and second prongs 3A, 3B via the alloy plate 4 results in deformation of the alloy plate 4 from its initial shape and causes untimely separation of the upper and lower electrical contacts 41, 3A1 from each other upon reaching a default value and owing to space apart of the lower end of the stop rod 22 from the alloy plate 4, thereby forming an open circuit between the first and second prongs 3A, 3B and preventing the switch from being damaged. The separation of the upper and lower electrical contacts 41, 3A1 is possible since a clearance exists between the lower end of the stop rod 22 and the upper surface of the alloy plate 4.

In this embodiment, the switch casing 1 and the button 2 are made from an insulated material and more preferably the stop rod 22 is integrally formed with the button 2.

The switch of the present invention further includes a third conductive prong 3C having lower prong sections exposed to an exterior of the interior chamber via the bottom for connection with the earth wire of the electrical power source (not visible).

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A switch comprising:
a switch casing defining an interior chamber with a bottom, including first and second conductive prongs having lower prong portions exposed to an exterior of said interior chamber via said bottom and upper prong portions located within said interior chamber, and a support unit, said upper prong portion of said first conductive prong being provided with a lower electrical contact;
a button mounted pivotally on said switch casing, having a first end provided with a connection rod extending into said interior chamber and a second end provided with a stop rod extending into said interior chamber; and
an alloy plate disposed within said interior chamber below said connection and stop rods, having one end connected securely to said upper prong portion of said second prong and a free end operably connected to said connection rod, said free end being provide with an upper electrical contact in alignment with said lower electrical contact of said first prong while said support unit biases said alloy plate from below such that when said button is switched on results in downward movement of said connection rod together with said alloy plate, thereby touching said upper and lower electrical contacts relative to each other while said stop rod is spaced apart from said alloy plate and when said button is switched off results in downward movement of said stop rod pressing against said alloy plate so as to separate said upper and lower electrical contacts from each other;
wherein, when an overload current flows through said first and second prongs via said alloy plate when said button is switched on results in deformation of said alloy plate from its initial shape and causes untimely separation of said upper and lower electrical contacts from each other upon reaching a default value owing to space apart of said stop rod from said alloy plate, thereby forming an open circuit and preventing the switch from being damaged.

2. The switch according to claim 1, wherein said button is made from an insulated material and said stop rod is integrally formed with said button.

3. The switch according to claim 1, further comprising a third conductive prong having lower prong sections exposed to an exterior of said interior chamber via said bottom for grounding and an upper prong portion located within said interior chamber.
